(19) United States
(12) Patent Application Publication
(10) Pub. No.: US 2011/0126550 A1
(43) Pub. Date: Jun. 2, 2011

(54) MAGNETOCALORIC REFRIGERATORS

(75) Inventors: Søren Linderoth, Roskilde (DK); Peter Vang Henriksen, Hillerod (DK); Stinus Jeppesen, Kobenhavn S (DK)

(73) Assignee: TECHNICAL UNIVERSITY OF DENMARK, Kgs. Lyngby (DK)

(21) Appl. No.: 13/002,033

(22) PCT Filed: Jul. 6, 2009
(86) PCT No.: PCT/EP09/58524

§ 371 Date: Feb. 15, 2011

Related U.S. Application Data
(60) Provisional application No. 61/078,886, filed on Jul. 8, 2008.

(51) Int. Cl. F25B 21/00; C09K 5/04

(52) U.S. Cl. 62/3.1; 252/67

(57) ABSTRACT

A magnetocaloric refrigerator uses as a refrigerant a magnetocaloric refrigerant material of the perovskite structure containing lanthanum and also containing Ce, Pr and Nd which may be of the general formula: LaₗCe_{c}PrₚNdₙREᵣAₐMnXₓO_{3-δ} wherein: A is at least one of the alkaline earth metals X if present is at least one metal selected from the group consisting of Co, Mn, Fe, Ni, Zn, Cu, Al, V, Ir, Mo, W, Pd, Pt, Mg, Ru, Rh, Cr and Zr, RE if present is at least one lanthanide other than La, Ce, Pr and Nd, the ratio of (l+c+p+n+r+a):(l+x) is from about 1:0.95 to about 1:1.15, the ratio of (l+c+p+n+r):(a) is from about 5:4 to about 7:2, x is from 0 to about 1:0.15, and −1<δ<1.

The present invention relates to the production of magnetocaloric refrigerators, i.e. refrigerators operating by magnetic refrigeration.

Most of refrigeration technologies for use in the near room temperature region such as refrigerators, freezers, and air-conditioners use a gas compression cycle and suffer from the disadvantage of using potentially environmentally damaging fluid refrigerants.

Magnetic refrigeration technologies use the magnetocaloric effect of magnetic materials in a refrigeration cycle instead of a gas compression cycle. Specifically, the refrigeration cycle is realized by using a magnetic entropy change of the magnetic material associated with a magnetic phase transition (which may be a phase transition between a paramagnetic state and a ferromagnetic state). In order to obtain highly efficient magnetic refrigeration, it is crucial to use a magnetic material which exhibits a high magnetocaloric effect around the temperature of operation, possibly in conjunction with other magnetocaloric materials exhibiting such an effect at selected adjacent temperatures.

The magnetocaloric effect has been studied in several lanthanum containing materials. These include manganite perovskite type materials and NaZn₁₃-type structure materials. In some cases the effect of substituting another lanthanide element for part of the lanthanum has been investigated (US2006/0231163; CN1170749; Chen et al, Journal of Magnetism and Magnetic Materials, 257 (2003), 254-257; Wang et al, Journal of Applied Physics, Vol 90, No. 11, 1 Dec. 2001)). The specific materials for which data is presented contain lanthanum plus just one other lanthanide. It should be expected that the inclusion of three further lanthanides alongside lanthanum would have an unpredictable and probably deleterious effect on the magnetic properties.

The lanthanum containing refrigerant materials are produced from raw materials comprising highly purified lanthanum or lanthanum sources such as oxides or nitrates and if desired another pure lanthanide.

We have now appreciated that satisfactory magnetocaloric refrigerant materials containing lanthanum can be produced using ‘lanthanum concentrate’, a commercially available mixed oxide containing lanthanum, cerium, praseodymium and neodymium as lanthanide components. This avoids the need to refine the original lanthanide bearing raw materials into separate pure lanthanides or reduces the necessary extent of the use of highly refined material where relative proportions of these lanthanides differing from those in lanthanide concentrate is desired. An alternative mixed lanthanide source that may be used in at least some instances is the lanthanum-rich mischmetal.

Thus, the present invention provides in a first aspect the use in the construction or operation of a magnetocaloric refrigerator of a La containing magnetocaloric refrigerant of the perovskite type also containing Ce, Pr and Nd. In a further aspect it provides a method of making a magnetocaloric refrigerator comprising preparing a magnetocaloric refrigerant material from starting materials which include lanthanum concentrate or a La-rich mischmetal and incorporating said magnetocaloric refrigerant material into a magnetocaloric refrigerator as the working refrigerant thereof. The invention includes in a further aspect a magnetocaloric refrigerator having as a working refrigerant a La containing magnetocaloric refrigerant material also containing Ce, Pr and Nd.

Lanthanide concentrate is obtainable from for instance Molycorp, Inc. Mountain Pass Calif. as product entitled ‘Code 5210 Lanthanum Concentrate’. The other large source of rare earths in the world is the Baotou Ore in Baotou, Inner Mongolia, where La is like in the Mountain Pass ore refined from bastnaesite.

Whilst the exact composition of lanthanide concentrate may vary somewhat between suppliers, it is an intermediate product produced during the purification of lanthanides from lanthanide ores. It generally contains La₂O₃, CeO₂, Pr₆O₁₁ and Nd₂O₃ in weight proportions on an oxide basis 100 La₂O₃: 5-30 CeO₂: 5-20 Pr₆O₁₁: 20-40 Nd₂O₃ or more commonly 100 La₂O₃: 10-21 CeO₂: 12-14 Pr₆O₁₁: 28-34 Nd₂O₃.

The use of lanthanum concentrate necessarily brings with it not only lanthanum but also each of the three other named lanthanides. However, the elements do not have to be in the above proportions in the magnetocaloric refrigerant, as additional purified lanthanide oxides can be added in the manufacture of the product so as to increase the proportion of any of the four lanthanides or to provide one or more further lanthanide elements.

Preferably, the lanthanum content of the refrigerant derives from a mixture of lanthanum concentrate and optionally in addition a more pure source of lanthanum and optionally in addition a more pure source of one or more further lanthanides.

An alternative mixed lanthanide source for use in the invention is a mischmetal. These materials which are again commercially available from Tianjiao International Co. ‘Code 9003 La Rich Mischmetal’. La-rich mischmetal typically contain:

La wt 58-65%

Ce wt 2-29%

Pr wt 3-35%

Nd wt 2-8%

A typical example is 61 wt % La, 2 wt % Ce, 35 wt % Pr, and 2 wt % Nd.

The magnetocaloric refrigerant may be of the manganite perovskite type, in which case preferably, the refrigerant is of the general formula:

LaₗCe_{c}PrₚNdₙREᵣAₐMnXₓO_{3-δ}

wherein:
A is at least one of the alkaline earth metals
X if present is at least one metal selected from the group consisting of Co, Mn, Fe, Ni, Zn, Cu, Al, V, Ir, Mo, W, Pd, Pt, Mg, Ru, Rh, Cr and Zr.
RE, if present, is at least one lanthanide other than La, Ce, Pr and Nd,
the ratio of (l+c+p+n+r+a):(l+x) is from about 1:0.95 to about 1:1.15,
the ratio of (l+c+p+n+r):(a) is from about 5:4 to about 7:2,
x is from 0 to about 0.15, and
−1<δ<1.

Preferred alkaline earth metals are magnesium, calcium, strontium and barium.

Preferably, l:(c+p+n+r)<10, more preferably <5, still more preferably <3. For instance, l:(c+p+n+r) may be from 10 to 1, more preferably from 5 to 1.25, still more preferably from 2.5 to 1.7, e.g. about 2.

Preferably, l:c<100 and more preferably l:c<50, and still more preferably <33 and still more preferably <25 and still more preferably <20.

Preferably, l:p<100 and more preferably l:p<50, and still more preferably <33 and still more preferably <25 and still more preferably <20.

Preferably, l:n<50 and more preferably l:n<17, and still more preferably <10 and still more preferably <7 and still more preferably <5.

Preferred compositions include:

La_{0.40-0.48}Ce_{0.01-0.05}Pr_{0.02-0.08}Nd_{0.11-0.19}Ca_{0.30-0.36}Mn_{0.95-1.05}O_{3+delta},

and

(La_{0.44}Ce_{0.03}Pr_{0.05}Nd_{0.15})₁₋ₓLaₓCa_{0.33}Mn_{1.05}O₃, x=[0:0.8]

Preferably, the total lanthanide sums to from 0.63 to 0.71, more preferably from 0.64 to 0.70, and most preferably to 0.66-0.68.

One preferred material is of the formula:

La_{0.44}Ce_{0.03}Pr_{0.05}Nd_{0.15}Ca_{0.33}Mn_{1.05}O₃

The specific content of the various lanthanides may be chosen to provide suitability for use as a refrigerant in a respective temperature range.

For instance, materials of the formula La_{0.40-0.48}Ce_{0.01-0.05}Pr_{0.02-0.08}Nd_{0.11-0.19}Ca_{0.30-0.36}Mn_{0.95-1.05}O_{3+delta} may be used as refrigerant in the temperature interval −100° C. to −70° C.

Materials of the formula La_{0.6-0.65}Ce_{0.006-0.03}Pr_{0.01-0.05}Nd_{0.07-0.13}Ca_{0.30-0.36}Mn_{0.95-1.05}O_{3+delta} may be used as refrigerant in the temperature interval −80° C. to −50° C.

Materials of the formula La_{0.75-0.78}Ce_{0.002-0.002}Pr_{0.004-0.02}Nd_{0.02-0.04}Ca_{0.30-0.36}Mn_{0.95-1.05}O_{3+delta} may be used as refrigerant in the temperature interval −50° C. to −20° C.

The materials described as cell materials for use in solid oxide fuel cells in U.S. Pat. No. 5,759,936 can be used as the magnetic refrigerant according to the present invention.

In an alternative aspect the invention includes the use in the construction or operation of a magnetocaloric refrigerator of a La containing magnetocaloric refrigerant also containing Ce, Pr and Nd which may be any of the magnetocaloric refrigerant materials as described above.

The invention further includes a method of making a magnetocaloric refrigerator having a working refrigerant, comprising preparing a magnetocaloric refrigerant material from starting materials which include lanthanum concentrate or a lanthanum-rich mischmetal and incorporating said magnetocaloric refrigerant material into a magnetocaloric refrigerator as the working refrigerant thereof.

A refrigerator in accordance with the invention may further comprise a source of magnetic field operable to increase and then decrease (optionally to zero) repeatedly a said magnetic field applied to said working refrigerant.

The refrigerator may further comprise a hot side heat exchanger and a cold side heat exchanger and a heat transfer fluid contained in a flow path for said heat transfer fluid connecting said hot side heat exchanger and said cold side heat exchanger via a location in which said heat transfer fluid is in heat exchange relationship with said working refrigerant.

The refrigerator may further comprise a pump mechanism connected to pump said heat transfer fluid from said location to said hot side heat exchanger after application of said magnetic field to said working refrigerant and to return said working fluid to said location and then to said cold side heat exchanger after reduction of said magnetic field applied to said working refrigerant.

The invention will be further described and illustrated with reference to the accompanying drawings in which:

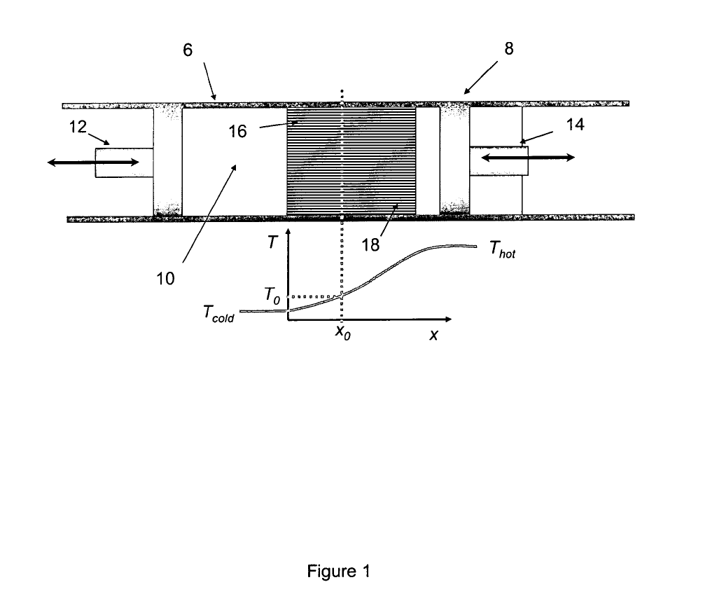

FIG. 1 shows a schematic representation of an example of a magnetic refrigerator according to the invention; and

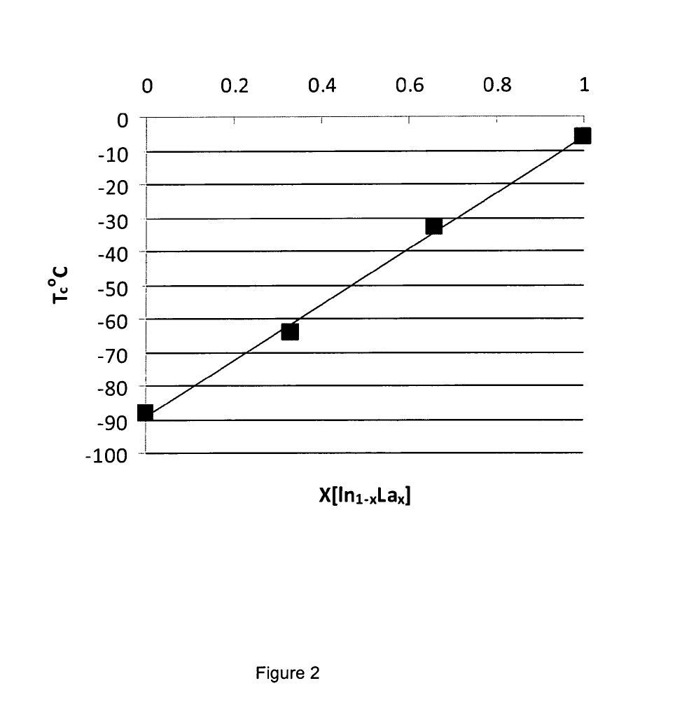

FIG. 2 shows a plot of the Curie temperature of a range of magnetocaloric materials of the general formula:

La(₁₋ₓ)LnₓCa_{0.33}Mn_{1.05}O₃,

x=[0,0.33,0.66,1]
where Ln=La_{0.44}Ce_{0.03}Pr_{0.05}Nd_{0.15}

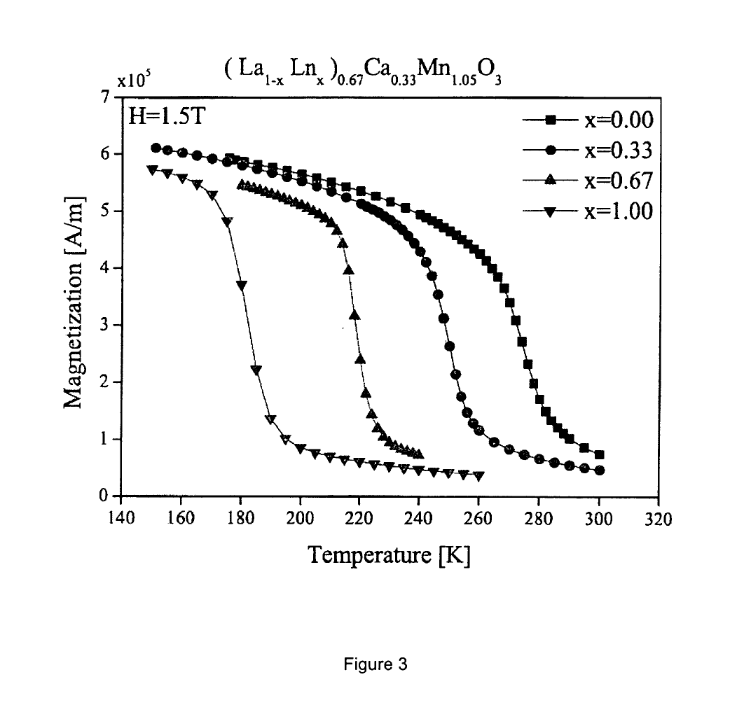

FIG. 3 shows magnetisation curves as a function of temperature for materials produced in Example 2.

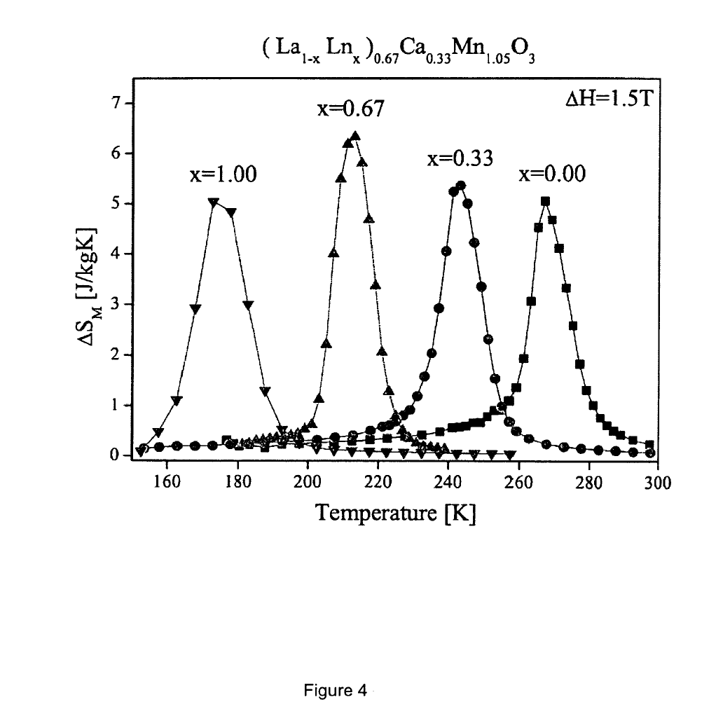

FIG. 4 shows entropy change curves as a function of temperature for the same materials.

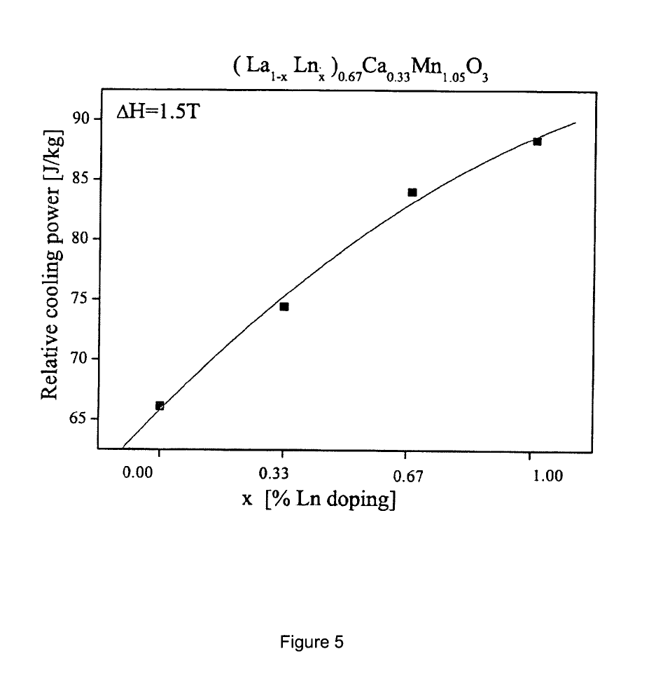

FIG. 5 shows the relative cooling power of the materials as a function of Ln doping level x.

The materials described herein may be used in essentially any form of magnetic refrigerator. This includes use in a magnetic refrigerator generally as described in WO2006/74790. As described there, the active component of a magnetic refrigerator, referred to as a magnetic regenerator, is formed of a magnetocaloric material, i.e. a material that heats up when placed in an applied magnetic field and cools when the field is removed. Such materials have been known for a long time and it has been recognised that they could be used for cooling purposes. Specifically, a typical active magnetic refrigerator comprises a magnetic regenerator arranged between a hot-side heat exchanger and a cold-side heat exchanger. A source of magnetic field is also provided. A heat transfer fluid is arranged to flow back and forth from the cold-side heat exchanger towards the hot-side heat exchanger through the magnetic regenerator in a cycle. A magnetic field is repeatedly applied to and removed from the magnetic regenerator, thereby causing it to heat up and cool down.

There are four stages to an active magnetic regenerator cycle. First, the application of a magnetic field warms the magnetic regenerator by the magnetocaloric effect, causing the heat transfer fluid within the regenerator to heat up. Second, heat transfer fluid flows in the direction from the cold-side heat exchanger to the hot-side heat exchanger. Heat is then released from the heat transfer fluid to the hot-side heat exchanger. Third, the magnetic regenerator is demagnetised, cooling the magnetocaloric material and the heat transfer fluid in the bed. Last, the heat transfer fluid flows through the cooled bed in the direction from the hot-side heat exchanger to the cold-side heat exchanger. The fluid takes up heat from the cold-side heat exchanger. The cold-side heat exchanger can then be used to provide cooling to another body or system.

FIG. 1 shows a schematic representation of an example of a magnetic refrigerator according to an embodiment of the present invention. The refrigerator comprises a magnetocaloric unit (4) arranged in thermal communication with each of a cold-side heat exchanger (6) and a hot-side heat exchanger (8). A heat transfer fluid (10) is provided for being forced back and forth through the magnetocaloric unit (4). In the example shown pistons (12) and (14) are provided for forcing the heat transfer fluid (10) through the magnetocaloric unit (4).

A magnet (not shown) is also provided for selectively applying a magnetic field to the magnetocaloric unit (4) and removing the magnetic field. The magnet may be a permanent magnet or an array of such magnets, an electromagnet or a solenoid. For low temperature applications the solenoid may be formed of superconductive material and be cooled by a cryogenic liquid such as liquid nitrogen.

In the specific example shown, a vertical section through the magnetocaloric unit is shown. The magnetocaloric unit (4) comprises plates (16) defining therebetween passages or paths (18) along which the heat transfer fluid flows.

In the embodiment shown, the magnetocaloric material used is graduated in composition across the magnetocaloric unit by variation of the chemical composition to alter the Curie temperature thereof. Decreasing the La content with respect to the other or total lanthanides produces a decreasing Curie temperature as shown in FIG. 2. Alternatively, the Curie temperature can be adjusted by varying the alkaline earth metal (e.g. Ca) content or by the extent of replacement of Mn by the element X in the manganite system.

This is illustrated in FIG. 1 by a graph of the variation of temperature of the magnetocaloric unit in the direction x, from the cold-side heat exchanger to the hot-side heat exchanger. A temperature gradient is established between the cold-side heat exchanger (6) and the hot-side heat exchanger (8). The temperature T(x) at any position x varies between temperatures T_{cold} and Tₕₒₜ. In view of the recognised fact that the magnetocaloric effect of a material varies with temperature and is at a maximum at or near the magnetic transition temperature of the material, the plates are formed such that the magnetic transition temperature of the plates (16) within the magnetocaloric unit (4) varies in the direction between the cold-side heat exchanger (6) and the hot-side heat exchanger (8).

To optimise the performance of the refrigerator, the material used in the form of the magnetocaloric unit (4) is selected so that at the position x₀, the unit (4) has a maximum magnetocaloric effect at temperature T₀. This ensures that the maximum possible magnetocaloric effect is achieved by the device. As will be explained below, this may be achieved by controlling and/or varying the composition of the material or powder used to form the unit (4).

The material or materials used to form the plates (16) of the magnetocaloric unit (4) in the example shown in FIG. 1 may be non-corroding materials, i.e. they are materials that substantially do not corrode upon exposure to a liquid such as a heat transfer fluid. The use of ceramic materials is particularly preferred due to its chemical stability towards corrosion.

In an example, two or more systems such as the one shown in FIG. 1 are arranged either in parallel or series. A moveable permanent magnet is provided enabling the magnet to be utilised continuously. When one regenerator is demagnetised the magnet can be used to magnetise one of the others.

In use, initially, the magnetocaloric unit (4) is demagnetised. Upon application of a magnetic field, the temperature of the magnetocaloric unit (4) rises due to a decrease in magnetic entropy and a corresponding increase in thermal entropy of the magnetic regenerator. Heat transfer fluid within the magnetocaloric unit increases in temperature with the magnetocaloric unit (4). The pistons (12) and (14) are then actuated to move to the right thereby forcing heat transfer fluid (10) to the left of the magnetocaloric unit into the spaces between the plates (16) and the heat transfer fluid that is within the magnetocaloric unit and therefore heated due to the rise in temperature of the magnetocaloric unit towards the hot-side exchanger (8).

In other words, the heat transfer fluid that is initially within the magnetic regenerator and is heated upon application of the magnetic field is forced towards the hot-side heat exchanger where it gives up some of the heat it has gained as a result of the application of the magnetic field.

The magnetic field is then removed, e.g., by the switching off of the magnetic field. This causes an increase in magnetic entropy and a corresponding decrease in thermal entropy. The magnetocaloric unit (4) thereby reduces in temperature. The heat transfer fluid within the magnetocaloric unit (4) at this stage undergoes a similar temperature drop due to the drop in temperature of the magnetocaloric unit (4). As the pistons move towards the left (in FIG. 1) this cooled heat transfer fluid is then forced, by the pistons (12) and (14), towards the left hand side of the refrigerator (the actual configuration shown in FIG. 1) and the cold-side heat exchanger (6) where it can receive heat, e.g. from an article being cooled. The cycle can then be repeated.

If a single magnetocaloric material is used, its operating range is likely to be narrow. This can be circumvented by using a series of materials each tuned to have optimum properties in a given temperature interval. The materials of the present invention have tunable magnetocaloric properties, where the substitution of La with cheaper materials not only leads to better commercial performance but also leads to better technical performance by the ability to design the magnetocaloric refrigerant material to perform in a certain working temperature range. Thus, changing the chemical composition makes it possible to control a variety of technologically important properties such as the magnitude of the magnetocaloric effect (MCE) and the usable temperature range as refrigerant i.e. the ferro- to paramagnetic transition temperature. By substituting some of the lanthanum in the composition with the less expensive lanthanum concentrate the price is lowered, and furthermore the technical performance of the material is improved. The following examples illustrate materials suitable for use in a refrigerator according to the invention.

### EXAMPLE 1

Commercial Lanthanum Concentrate containing 40% La₂O₃, 4% CeO₂, 5.5% Pr₆O₁₁ and 13,5% Nd₂O₃ plus 1% other lanthanides is dissolved in 65% HNO₃. This solution is mixed with solutions of Ca(NO₃)₂, Sr(NO₃)₂and Mn(NO₃)₂ in quantities according to the chemical formula:

La_{0.44}Ce_{0.03}Pr_{0.05}Nd_{0.15}Ca_{0.33}Mn_{1.05}O₃

The resulting mixed salt solution is added glycine in order to obtain a glycine/nitrate ratio of approximately 0.6. The solution is boiled down to remove excess water. Finally the viscous solution starts to form a foam before it self-ignites making a ceramic powder. The powder is afterwards heat treated to obtain single phase perovskite. The powder can be used as refrigerant by sintering into different shapes obtained by pressing, tapecasting, rolling etc. for the appropriate shape.

### EXAMPLE 2

A set of materials were synthesised. Lanthanum concentrate was simulated by mixing laboratory grade purity lanthanide oxides to form a mixture having the lanthanide content Ln:

La_{65.5}Ce_{4.5}Pr_{7.5}Nd_{22.5}.

Using the general method described in Example 1, the following compositions were made:

### 1. (La_{1.00}Ln_{0.00})_{0.67}Ca_{0.33}Mn_{1.05}O₃

### 2 (La_{0.67}Ln_{0.33})_{0.67}Ca_{0.33}Mn_{1.05}O₃

### 3. (La_{0.33}Ln_{0.67})_{0.67}Ca_{0.33}Mn_{1.05}O₃

### 4. (La_{0.00}Ln_{1.00})_{0.67}Ca_{0.33}Mn_{1.05}O₃

The compositions are therefore represented by the formula:

La₁₋ₓLnₓ)_{0.67}Ca_{0.33}Mn_{1.05}O₃

where x varies from 0 to 1.

Powders of each composition were produced using the glycine/nitrate method described above and were calcined at 700° C. and subsequently dry pressed and sintered at 1200° C.

The samples were characterised by XRD and were found to be well crystallised having an orthorhomically distorted perovskite structure with the spacegroup Pbnm. The XRD patterns were investigated by Rietveld refinement and it was found that as doping increases the unit cell volume decreases. This is explicable on the basis that the ionic radii of all the lanthanides being substituted for lanthanum are smaller than that of lanthanum. The valencies of Nd and Pr are known to be Ne and Pr³⁺ and Ce is known to exist in the mixed valency state Ce³⁺/Ce⁴⁺. Thus, the average ionic size at the site normally occupied by lanthanum (the ‘A site’) will decrease with increasing doping with Ln. This we would predict would lead to an decreasing Mn—O—Mn bond angle and a decreasing transition temperature. We therefore predict a decreasing Curie temperature with increasing Ln substitution. Magnetisation curves as a function of temperature for these compositions are shown in FIG. 3. Entropy of magnetisation change ΔS_{M}[J/KgK] against temperature upon the application of a field of 1.5 T for these materials is plotted in FIG. 4. A value often used to describe the potential of magnetocaloric materials is the relative cooling power (RCP), which is given by:

RCP=ΔS_{M,max}×δ_{FWHM}

where ΔS_{M,max} is the maximum value and δ_{FWHM} is the full width at half maximum of the peak in entropy change shown in FIG. 4. The RCP values for the materials plotted against the Ln fraction is seen in FIG. 5.

A clear and not trivially expected advantageous effect on the RCP is observed with increasing X corresponding to increased use of the lanthanide mix

In this specification, unless expressly otherwise indicated, the word ‘or’ is used in the sense of an operator that returns a true value when either or both of the stated conditions is met, as opposed to the operator ‘exclusive or’ which requires that only one of the conditions is met. The word ‘comprising’ is used in the sense of ‘including’ rather than in to mean ‘consisting of’. All prior teachings acknowledged above are hereby incorporated by reference. No acknowledgement of any prior published document herein should be taken to be an admission or representation that the teaching thereof was common general knowledge in Australia or elsewhere at the date hereof.

1. A magnetocaloric refrigerator having as a working refrigerant a magnetocaloric refrigerant material of the perovskite structure containing lanthanum and also containing Ce, Pr and Nd.

2. A refrigerator as claimed in claim 1, further comprising a source of magnetic field operable to increase and then decrease repeatedly a said magnetic field applied to said working refrigerant.

3. A refrigerator as claimed in claim 2, further comprising a hot side heat exchanger and a cold side heat exchanger and a heat transfer fluid contained in a flow path for said heat transfer fluid connecting said hot side heat exchanger and said cold side heat exchanger via a location in which said heat transfer fluid is in heat exchange relationship with said working refrigerant.

4. A refrigerator as claimed in claim 3, further comprising a pump connected to pump said heat transfer fluid from said location to said hot side heat exchanger after application of said magnetic field to said working refrigerant and to return said working fluid to said location and then to said cold side heat exchanger after reduction of said magnetic field applied to said working refrigerant.

5. A refrigerator as claimed in claim 1, wherein said magnetocaloric refrigerant material is of the general formula:
LaₗCe_{c}PrₚNdₙREᵣAₐMnXₓO_{3-δ}
wherein:
A is at least one of the alkaline earth metals
X if present is at least one metal selected from the group consisting of Co, Mn, Fe, Ni, Zn, Cu, Al, V, Ir, Mo, W, Pd, Pt, Mg, Ru, Rh, Cr and Zr,
RE if present is at least one lanthanide other than La, Ce, Pr and Nd,
the ratio of (l+c+p+n+r+a):(l+x) is from about 1:0.95 to about 1:1.15,
the ratio of (l+c+p+n+r):(a) is from about 5:4 to about 7:2,
x is from 0 to about 1:0.15, and
−1<δ<1.

6. A refrigerator as claimed in claim 5, wherein l:(c+p+n+r)<1:0.1.

7. A refrigerator as claimed in claim 6, wherein l:(c+p+n+r)<1:0.2.

8. A refrigerator as claimed in claim 7, wherein l:(c+p+n+r)<1:0.3.

9. A refrigerator as claimed in claim 5, wherein l:(c+p+n+r) is from 1:0.1 to 1:1.

10. A refrigerator as claimed in claim 9, wherein l:(c+p+n+r) is from 1:0.2 to 1:0.8.

11. A refrigerator as claimed in claim 10, wherein l:(c+p+n+r) is from 1:0.4 to 1:0.6.

12. A refrigerator as claimed in claim 5, wherein said magnetocaloric material is of the general formula:
La_{0.40-0.48}Ce_{0.01-0.05}Pr_{0.02-0.08}Nd_{0.11-0.19}Ca_{0.30-0.36}Mn_{0.95-1.05}O_{3+delta},
wherein the total lanthanide sums to from 0.63 to 0.71.
